(19) United States
(12) Patent Application Publication
(10) Pub. No.: US 2004/0245053 A1
(43) Pub. Date: Dec. 9, 2004

(54) Method of controlling an electromechanical aircraft brake

(75) Inventors: Philippe Chico, Rueil-Malmaison (FR); Pierre Girod, Paris (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI

(21) Appl. No.: 10/853,267

(22) Filed: May 26, 2004

(30) Foreign Application Priority Data
Jun. 6, 2003 (FR) 0306852

(51) Int. Cl. F16D 55/36

(52) U.S. Cl. 188/71.5

(57) ABSTRACT

The invention provides a method of controlling an electromechanical aircraft brake comprising a stack of disks and a ring carrying a plurality of electromechanical actuators each fitted with a pusher that is movable in register with the stack of disks under drive from an associated electric motor so that rotation of the motor in a first direction causes the pusher to be pressed against the stack of disks. According to the invention, the method comprises the step of causing at least one motor to rotate in a second direction opposite to the first direction so as to cause the corresponding pusher to reverse beyond a distance corresponding to normal operating clearance between the pusher and the stack of disks.

The invention relates to a method of controlling an electromechanical aircraft brake.

### BACKGROUND OF THE INVENTION

Aircraft brakes comprise a stack of disks comprising one portion (rotors) constrained to rotate with the wheel and another portion (stators) prevented from rotating, a presser member being disposed facing the stack of disks in order to press against the stack, thereby dissipating energy by friction between the rotating disks and the stationary disks.

With a hydraulic brake, the presser member comprises a ring extending in register with the stack of disks and having pistons mounted on the ring to press it against the stack of disks under drive from a hydraulic fluid under pressure.

While the brake is not active, the pistons are in a waiting position close to the disks, leaving operating clearance of the order of a few millimeters, which corresponds to the stroke proper of the pistons. Disk wear leads to a reduction in the thickness of the stack of disks, and this can amount to as much a several tens of millimeters, so a wear takeup mechanism is generally provided made up of deformable elements or friction elements that enable the pistons to be held close to the stack of disks regardless of the degree of wear of the disks.

When worn disks are replaced by new disks, it is therefore necessary to reinitialize the wear takeup mechanism in order to return the pistons to a position that enables a stack of new disks to be put into place.

For that purpose, with certain types of brake, it is known to reinitialize each of the wear takeup mechanisms by means of a press. It is therefore necessary to remove the ring and install it in special tooling.

In other types of brake, it is necessary to remove the elements of the wear takeup mechanism in order to replace them with new mechanisms.

In both cases, reinitializing the wear takeup mechanism requires the brake to be removed and the ring to be separated from the structure of the brake. These operations are lengthy and expensive.

In the field of hydraulic brakes, it turns out to be impossible to cause the pistons to reverse in a manner that is simple.

New brakes proposed in the field of aviation are more and more often of the electromechanical type in which the piston(s) is/are replaced by one or more electromechanical actuators comprising a pusher mounted to move in register with the disks, the pusher being actuated by means of an electric motor via a converter for converting rotation of the motor into displacement of the pusher.

Document U.S. Pat. No. 6,471,015 describes a disk-wear measuring system configured to estimate the thickness of the disks and to deduce therefrom a waiting position for each pusher in which it is spaced apart from the disks by predetermined clearance. Conventional techniques are used to reverse the pushers from the contact position to the waiting position.

By way of technological background, mention can also be made of US-A-2001/0023798 which teaches withdrawing a pusher from a motor vehicle disk brake of caliper architecture in order to change the brake pads.

The total displacement stroke of the pusher in electromechanical brakes of present design is quite long so as to enable wear to be taken up merely by turning the electric motor in a direction that tends to move the pusher towards the stack of disks, such that the pusher is maintained close to the stack of disks without using a specific wear takeup mechanism.

A direct application of the reinitialization procedures known in the field of hydraulic brakes to the field of electromechanical brakes does not give satisfaction. In most cases, press reinitialization is not possible since the converter is not reversible, whereas reinitialization by disassembly is difficult, since the actuators are technical elements that are much more complicated than hydraulic pistons.

### OBJECT OF THE INVENTION

An object of the invention is to propose a method of controlling electromechanical brakes that take advantage of the possibilities made available by such technology to obtain new and advantageous functions that are not available with hydraulic technology.

### BRIEF SUMMARY OF THE INVENTION

There is provided a method of controlling an electromechanical aircraft brake comprising a stack of disks and a ring carrying a plurality of electromechanical actuators each fitted with a pusher that is movable in register with the stack of disks under drive from an associated electric motor so that rotation of the motor in a first direction causes the pusher to be pressed against the stack of disks, the method comprising, according to the invention, the step of causing at least one motor to rotate in a second direction opposite to the first direction so as to cause the corresponding pusher to reverse beyond a distance corresponding to normal operating clearance between the pusher and the stack of disks.

Thus, unlike the pistons of hydraulic brakes, the pusher is no longer constrained to remain permanently close to the disks, but can be moved away therefrom in very simple manner merely by controlling the electric motor. Reversing the pusher therefore no longer requires special tooling or disassembly, but merely requires electrical power to be applied to cause the actuator motor to turn.

This possibility makes it possible to envisage new applications, some of which are set out below.

In a first application of the invention intended more particularly for enabling the brake to be maintained easily, the pusher is reversed sufficiently to enable a stack of new disks to be put into place, replacing a stack of worn disks.

Thus, the ability to reverse the pusher easily in accordance with the invention enables sufficient space to be released to receive a stack of new disks, i.e. a stack of greater thickness.

This capacity thus avoids any need to remove the brake and make use of special tooling for reversal purposes.

Advantageously, the pusher is reversed while the actuator is still secured to the aircraft.

Reversal can thus be performed while the brake is still in place on the aircraft, e.g. in the context of a procedure that is launched automatically by means of the onboard power supply of the aircraft, each time action is taken on the brake.

Alternatively, the pusher may be reversed by using a power supply external to the aircraft, either because the power supply on board the aircraft is not in operation, or else because the portion of the brake which includes the actuator has been removed from the aircraft.

In a second possible application of the method of the invention, the pusher is reversed to a reference position that is independent of the thickness of the stack of disks.

This enables the position of the pusher to be reset relative to said reference position. Advantageously, said reference position corresponds to a retraction abutment of the pusher.

Provision can be made for the pusher of one of the actuators to press against the stack of disks while the pusher of at least one other one of the actuators is reversed to the reference position.

Advantageously, the pushers of all the actuators are reversed to the reference position.

In an advantageous aspect of the invention, reversal of the pusher to the reference position is preceded or followed by the pusher being moved towards the stack of disks until the pusher comes into contact with the stack of disks.

This disposition makes it very simple to measure disk wear.

In another variant of the method of the invention, the reversal step forms part of a preprogrammed test procedure for the actuator in question.

Finally, provision can be made for the reversal step to be performed simultaneously on at least two actuators, and preferably on all of the actuators.

### BRIEF DESCRIPTION OF THE DRAWING

The invention will be better understood in the light of the following description given with reference to the figures of the accompanying drawing, in which:

FIG. 1 is a section view of an electromechanical brake mounted on an aircraft, with a stack of disks that are new; and

FIG. 2 is a view analogous to FIG. 1, with the brake being shown fitted with a stack of disks that are worn.

### DETAILED DESCRIPTION OF THE INVENTION

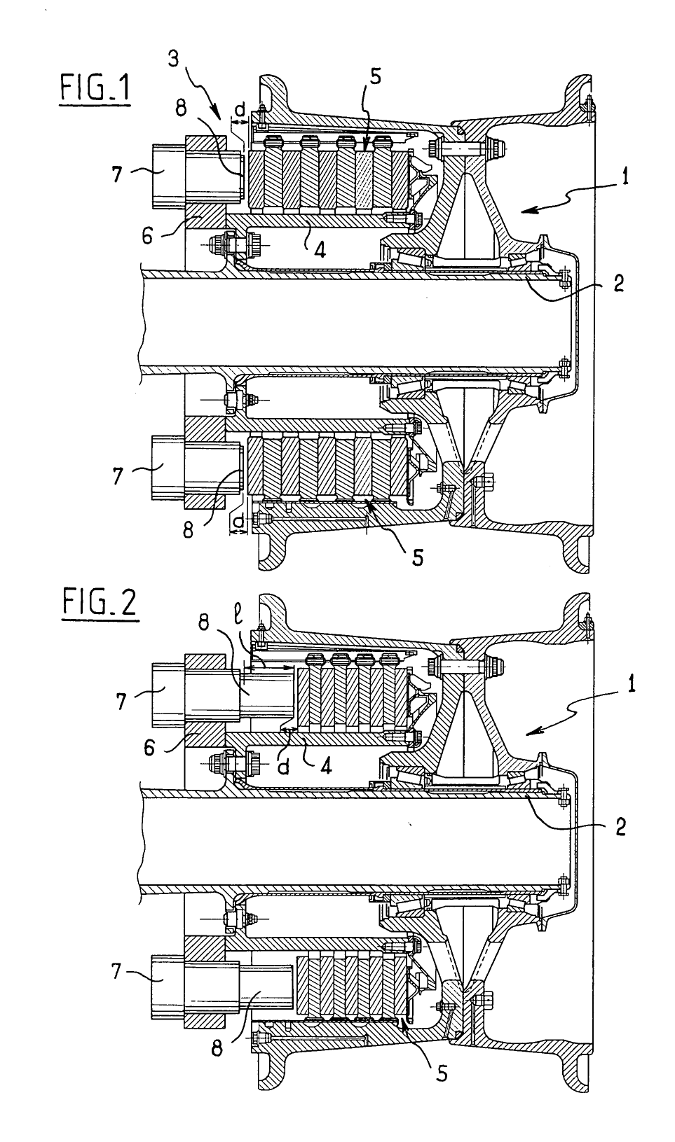

With reference to FIG. 1, an aircraft wheel 1 is mounted to rotate on an axle 2 (the tire carried by the wheel not being shown in the drawing).

An electromechanical brake 3 is mounted on the axle 2 for the purpose of braking the wheel 1.

The brake 3 comprises a torsion tube 4 which is detachably secured to the axle 2. Between the torsion tube 4 and the wheel 1 there extends a stack of disks 5 made up firstly of disks (rotors 5) that are constrained to rotate with the wheel and that therefore turn therewith, and secondly by disks (stators) that are constrained to rotate with the torsion tube, and which are therefore prevented from rotating.

The brake 3 also comprises a ring 6 secured to the torsion tube 4 and carrying a plurality of electromechanical actuators 7.

Each of the actuators 7 comprises an electric motor (not shown in the figures), a pusher 8 that is movable in a direction parallel to the axis of the wheel 1, and a converter (not shown in the figures) for converting the rotary movement of the motor into translation movement of the pusher 8.

Rotating a motor in a first direction tends to cause the corresponding pusher 8 to be extended, thereby causing the pusher 8 to move closer to the stack of disks 5 until it comes into contact therewith and applies pressure to the stack of disks 5 tending to cause the facing faces of the rotating disks and the stationary disks to rub against one another. This produces a braking action on the wheel 1 due to friction between the disks.

In order to ensure that the brake has a very fast reaction speed, the pushers 8 are maintained close to the stack of disks while the brake is not in action, at a distance d corresponding to normal operating clearance, which in practice is of the order of a few millimeters. This clearance allows the wheel 1 to rotate freely, and it is determined so as to avoid any undesired contact between the pushers 8 and the stack of disks at the end of a braking operation while the disks are very hot and they expand, or when the torsion tube shrinks on cooling.

For this purpose, at the end of a braking operation, the electric motor is powered so as to cause it to rotate in a second direction that tends to retract the pusher 8. After storing a position in which the corresponding pusher 8 is in contact against the stack of disks 5, the pusher is reversed through the predetermined distance d, measured from said contact position, so as to place the pusher 8 in a waiting position (as shown) in the immediate vicinity of the disks.

It should be observed that the waiting position for the pusher 8 is not fixed, but depends on the state of wear of the disks in the stack of disks.

As the disks become worn, the total thickness of the stack of disks decreases, so the waiting position of the pusher 8 corresponds to a position that is ever more extended. In FIG. 2, which shows a stack of disks in the maximum wear state, it can be seen that the waiting position of the pusher 8 corresponds to a position of the pusher that is much more extended than that shown in FIG. 1, where the disks are still new.

In the invention, and in the context of maintenance operations being performed on the brake, at least one of the motors is powered so as to cause it to rotate in the second direction, thereby causing the corresponding pusher to reverse through a distance e (of the order of several tens of millimeters), that is sufficient to enable the stack of worn disks to be replaced by a thicker stack of new disks.

Thus, the ability to reverse, which is made possible by the electromechanical technology used, is no longer used solely for organizing operating clearance between the pushers and the stack of disks, but is advantageously also used in accordance with the invention to simplify brake maintenance to a very considerable extent. The reversal performed in this way eliminates any need to have recourse to special tooling such as a press, and avoids any need to remove each actuator itself, an operation that is difficult and must be performed by specialized personnel.

Reversal can be performed while the brake is still mounted on the aircraft, which presents several advantages. Firstly, it is possible to make use of the power supply on board the aircraft to perform this reversal without any special cabling or connection being needed. Secondly, this naturally protects the pushers 8 from being hit by tools, and also protects them from being polluted by the carbon dust from the disks that will inevitably escape when the brake is handled during maintenance.

Pusher reversal is advantageously performed as part of an automatic procedure that is triggered before each operation on the brake, either at the initiative of the pilot of the aircraft, or else at the initiative of a maintenance operative.

In a variant, this reversal can be performed while the portion of the brake that supports the actuators (in this case specifically the ring 6) is no longer secured to the aircraft. This applies when the brake 3 is removed from the aircraft and taken into a workshop for maintenance.

Under such circumstances, the invention provides several possibilities: firstly the pushers 8 can be caused to reverse while the ring 6 is still secured to the torsion tube 4. It is also possible to reverse the pushers 8 once the ring 6 has been separated from the torsion tube 4 (for these first two options, and also for reversing the pushers in the above-mentioned case while the brake is still secured to the aircraft, it is advantageous to cause all of the pushers to reverse simultaneously). It is also possible to cause the pusher of an actuator to reverse after the actuator has been separated from the ring 6, whether or not the ring is still secured to the torsion tube 4.

When necessary, e.g. in a workshop, a power supply is used that is external to the aircraft for the purpose of powering the motor of the actuator(s).

Reversal of the pusher of an actuator beyond normal operating clearance in accordance with the invention can be used to provide other functions.

In one of them, reversal is used to make it possible to verify that a sensor for sensing the position of the pusher 8 of at least one of the actuators 7 is operating properly. To do this, the pusher 8 is reversed to a reference position that is independent of the thickness of the stack of disks 5, e.g. until it has become retracted into abutment.

This reversal to the reference position makes it possible to verify that the position sensor is operating properly by ensuring that the value it provides when the pusher has been reversed to said position does indeed correspond to the expected value.

This reversal also makes it possible to reset said position sensor, by reinitializing it to a determined value when the pusher is in said reference position.

Such resetting can form part of an automatic brake test procedure that is performed occasionally or regularly prior to each actuation of the brake.

In another function, at least two actuators are caused to reverse to the reference position, and it is verified that the values given by the position sensors of the actuators are mutually compatible.

In another function offered by reversing the pusher in accordance with the invention, it is possible to evaluate disk wear. To do this, reversal of the pusher to a reference position is preceded or followed by advancing the pusher towards the stack of disks until said pusher comes into contact therewith.

By reading the values from the position sensor when the pusher is in the reference position and when the pusher is in contact with the stack of disks, and by taking the difference, a value is obtained that is representative of disk wear.

Reversal of the pusher in accordance with the invention thus makes it possible at any time to determine accurately the degree of disk wear, and thus to trigger maintenance for replacing the stack of disks once a critical degree of wear is reached. Such estimation of wear can also form part of an automatic brake test procedure that is performed occasionally or systematically prior to each actuation of the brake.

In a particular implementation, one of the actuators is used to press against the stack of disks while at least one other actuator is used for measuring wear using the method described above.

By compressing the disks, it is possible to guarantee that all of the disks are pressing against one another without clearance between the disks, which might otherwise falsify the measurement of wear.

The invention is not limited to the particular modes described above, but on the contrary it covers any variant that comes within the ambit of the invention as defined by the claims.

In particular, the method may be applied to an electromechanical brake having actuators which are not mounted on a ring secured to the brake, but which are mounted directly to the structure of the aircraft. This applies in particular when the ring 6 is not secured to the torsion tube 4, but instead to the axle 2.

What is claimed is:

1. A method of controlling an electromechanical aircraft brake comprising a stack of disks and a ring carrying a plurality of electromechanical actuators each fitted with a pusher that is movable in register with the stack of disks under drive from an associated electric motor so that rotation of the motor in a first direction causes the pusher to be pressed against the stack of disks, the method comprising the step of causing at least one motor to rotate in a second direction opposite to the first direction so as to cause the corresponding pusher to reverse beyond a distance corresponding to normal operating clearance between the pusher and the stack of disks.

2. A method according to claim 1, wherein the pusher is reversed sufficiently to enable a stack of new disks to be put into place, replacing a stack of worn disks.

3. A method according to claim 2, wherein the pusher is reversed while the actuator is still secured to the aircraft.

4. A method according to claim 2, wherein, in order to reverse the pusher, the motor of the actuator is powered from a power supply external to the aircraft.

5. A method according to claim 1, wherein the pusher is reversed to a reference position that is independent of the thickness of the stack of disks.

6. A method according to claim 5, wherein said reference position corresponds to a retraction abutment of the pusher.

7. A method according to claim 5, wherein reversal of the pusher to the reference position is preceded or followed by advancing the pusher until it comes into contact with the stack of disks.

8. A method according to claim 5, wherein the pusher of one of the actuators is pressed against the stack of disk while the pusher of at least one other one of the actuators is reversed to the reference position;

9. A method according to claim 5, wherein the pushers of all of the actuators are reversed to the reference position.

10. A method according to claim 1, wherein the step of reversing the pusher forms part of a preprogrammed procedure for testing the actuator in question.

11. A method according to claim 1, wherein the reversal step is performed simultaneously on at least two actuators, and preferably on all of the actuators.
